(19) United States
(12) Patent Application Publication
(10) Pub. No.: US 2004/0243538 A1
(43) Pub. Date: Dec. 2, 2004

(54) Interaction with a three-dimensional computer model

(76) Inventors: Ralf Alfons Kockro, Eucalia Block (SG); Chee Keong Eugene Lee, Marine Parade (SG)

Correspondence Address: KRAMER LEVIN NAFTALIS & FRANKEL LLP, INTELLECTUAL PROPERTY DEPARTMENT, 919 THIRD AVENUE, NEW YORK, NY, 10022, US

(21) Appl. No.: 10/489,463

(22) PCT Filed: Sep. 12, 2001
(86) PCT No.: PCT/SG01/00182

(51) Int. Cl. G06F 7/00

(52) U.S. Cl. 707/1

(57) ABSTRACT

A system is presented permitting a user to interact a three-dimensional model. The system displays an image of the model in a workspace. A processor of the system defines (i) a virtual plane intersecting with the displayed model and (ii) a correspondence between the virtual plane and a surface. The user positions a tool on the surface to select a point on that surface, and the corresponding position on the virtual plane defines a position in the model in which a change to the model should be made. Since the user moves the tool on the surface, the positioning of the tool is accurate. In particular, the tool is not liable to be jogged away from its desired location if the user operates a control device (such as a button) on the tool.

### FIELD OF THE INVENTION

The present invention relates to methods and systems for interacting with a three-dimensional computer model.

### BACKGROUND OF THE INVENTION

One existing technology for displaying three dimensional models is called the Dextroscope, which is used for visualisation by a single individual. A variation of the Dextroscope, for use in presentations to an audience, and even a large audience, is called the DextroBeam. This Dextroscope technology displays a high-resolution stereoscopic virtual image in front of the user.

The software of the Dextroscope uses an algorithm having a main loop in which inputs are read from the user's devices and actions are taken in response. The software creates a “virtual world” which is populated by virtual “objects”. The user controls a set of input devices with his hands, and the Dextroscope operates such that these input devices correspond to virtual “tools”, which can interact with the objects. For example, in the case that one such object is virtual tissue, the tool may correspond to a virtual scalpel which can cut the tissue.

There are three main stages in the operation of the Dextroscope: (1) Initialization, in which the system is prepared, followed by an endless loop of (2) Update, in which the input from all the input devices are received and the objects are updated, and (3) Display, in which each of the updated objects in the virtual world is displayed in turn.

Within the Update stage, the main tasks are:

reading all the input devices connected to the system.

finding out how the virtual tool relates to the objects in the virtual world

acting on the objects according to the programmed function of the tool

updating all objects

The tool controlled by the user has four states: “Check”, “StartAction”, “DoAction” and “EndAction”. Callback functions corresponding to the four states are provided for programming the behaviour of the tool.

“Check” is a state in which the tool is passive, and does not act on any object. For a stylus (a three-dimensional-input device with a switch), this corresponds to the “button-not-pressed” state. The tool uses this time to check the position with respect to the objects, for example if is touching an object.

“StartAction” is the transition of the tool from being passive to active, such that it can act on any object. For a stylus, this corresponds to a “button-just-pressed” state. It marks the start of the tool's action, for instance “start drawing”. DoAction is a state in which the tool is kept active. For a stylus, this corresponds to “button-still-pressed” state. It indicates that the tool is still carrying out its action, for instance, “drawing”. EndAction is the transition of the tool from being active to being passive. For a stylus, this corresponds to “button-just-released” state. It marks the end of the tool's action, for instance, “stop drawing”.

A tool is typically modelled such that its tip is located at object co-ordinates (0,0,0), and it is pointing towards the positive z-axis. The size of a tool should be around 10 cm. A tool has a passive shape and an active shape, to provide visual cues as to which states it is in. The passive shape is the shape of the tool when it is passive, and active shape is the shape of the tool when it is active. A tool has default passive and active shape.

A tool acts on objects when it is in their proximity. A tool is said to have picked the objects. Generally, a tool is said to be “in” an object if its tip is inside a bounding box of the object. Alternatively, the programmers may define an enlarged bounding box which surrounds the object with a selected margin (“allowance”) in each direction, and arrange that the software recognises that a tool is “in” an object if its tip enters the enlarged bounding box. The enlarged bounding box enables easier picking. For example, one can set the allowance to 2 mm (in the world's coordinate system, as opposed to the virtual world), so that the tool will pick an object if it is within 2 mm of the object's proximity. The default allowance is 0.

Although the Dextroscope has been very successful, it suffers from the shortcoming that a user may find it difficult to accurately manipulate the tool in three dimensions. In particular, the tool may be jogged when the button is pressed. This can lead to various kinds of positioning errors.

### SUMMARY OF THE INVENTION

The present invention seeks to provide a new and useful ways to interact with three-dimensional computer generated models efficiently.

In general terms, the present invention proposes that the processor of the model display system defines (i) a virtual plane intersecting with the displayed model and (ii) a correspondence between the virtual plane and a surface. The user positions the tool on the surface to select a point on that surface, and the corresponding position on the virtual plane is a position in the model in which a change to the model should be made. Since the user moves the tool on the surface, the positioning of the tool is more accurate. In particular, the tool is less liable to be jogged away from its desired location if the user operates a control device (e.g. button) on the tool.

Specifically, the invention proposes a computer-implemented method for permitting a user to interact with a three-dimensional computer model, the method including:

storing the model, a mapping defining a geometrical correspondence between portions of the model and respective portions of a real world workspace, and data defining a virtual plane in the workspace;

and repeatedly performing a set of steps consisting of:

generating an image of at least part of the model;

determining the position of an input device on a solid surface;

determining a corresponding location on the virtual plane; and

modifying the portion of the model corresponding under the mapping to the determined location on the virtual plane.

Furthermore, the invention provides an apparatus for permitting a user to interact with a three-dimensional computer model, the apparatus including:

a processor for storing the model, a mapping defining a geometrical correspondence between portions of the model and respective portions of a real world workspace, and data defining a virtual plane in the workspace;

display means controlled by the processor and for generating an image of at least part of the model;

an input device for motion on a solid surface; and

a position sensor for determining the position of the input device on the surface;

the processor being arranged to use the determined position on the surface to determine a corresponding location on the virtual plane, and to modify the portion of the model corresponding under the mapping to the location on the virtual plane.

The processor may determine the corresponding location on the virtual plane by defining a virtual line (“virtual line of sight”) extending from the position on the surface to a position representative of the eye of the user, and determining the corresponding location on the virtual plane as the point of intersection of the line and the virtual plane.

For example, in a form of the invention which is particularly suitable for use in the Dextroscope system, the position representative (3D location and orientation) of the eye of the user is the actual position of an eye of the user, which is indicated to the computer using known position tracking techniques, or an assumed position of the user's eye (e.g. if the user is instructed to use the device when his head is in a known position). In this case, the display means preferably displays the model at an apparent location in the workspace given by the mapping.

Alternatively, in a form of the invention which is particularly suitable for example for use in the DextroBeam system, the position representative of the position of the eye (“virtual eye”) does not (usually) coincide with the actual position of the eye. Instead, we can consider a first region of the workspace containing the virtual eye, the surface, the tool, the virtual plane and the position of the model under the mapping. This first region has a relationship (second mapping) to second region containing the real eye. The position (3D location and orientation) of the real eye in the second region corresponds under the second mapping to the position of the virtual eye in the first region. Similarly, the apparent location of the image of the model in the second region corresponds under the second mapping to the position of the model in the first region according to the first mapping.

Note that the present invention is applicable to making any changes to a model. For example, those changes may be to supplement the model by adding data to it at the point specified by the intersection of the virtual line and plane (e.g. drawing a contour on the model). Alternatively, the changes may be to remove data from the model. Furthermore, the changes may merely alter a labelling of the model within the processor which alters the way in which the processor displays the model, e.g. so that the user can use the invention to indicate that sections of the model are to be displayed in a different colour or not displayed at all.

Note that the virtual plane may not be displayed to the user. Furthermore, the user may not be able to see the tool, and a virtual tool representing the tool may or may not be displayed.

### BRIEF DESCRIPTION OF THE FIGURES

A non-limiting embodiment of the invention will now be described in detail with reference to the following figures, in which:

FIG. 1 is a first view of the embodiment of the invention; and

FIG. 2 is a second view of the embodiment of FIG. 1.

### DETAILED DESCRIPTION OF THE EMBODIMENTS

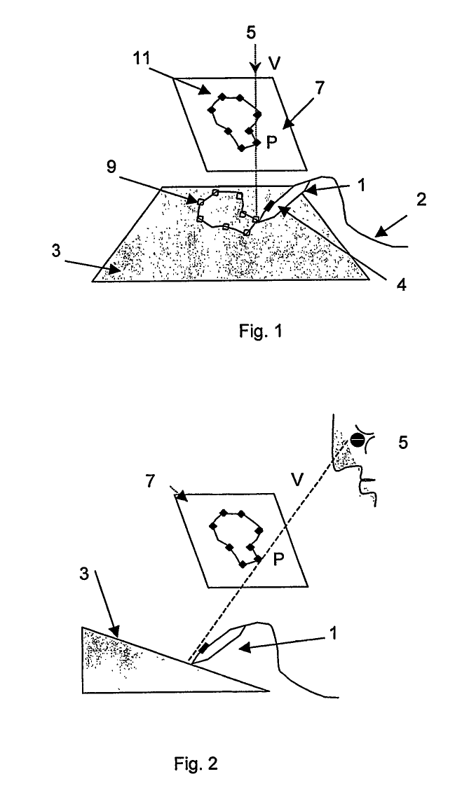

FIGS. 1 and 2 are two views of an embodiment of the invention. The view of FIG. 2 is from the direction which is to one side of FIG. 1. Many features of the construction of the embodiment are the same as the known Dextroscope system. However, embodiment permits a user to interact with a three-dimensional model by moving a tool (stylus) 1 while the tip of the tool 1 rests on a surface 3 (usually the top of a table, or an inclined plane). The position of the tip of the tool 1 is monitored using known position tracking techniques, and transmitted to a computer (not shown) by wires 2.

A position representative of the position of a user's eye is indicated as 5. This may be the actual position of an eye of the user, which is indicated to the computer using known position tracking techniques, or an assumed position of the user's eye (e.g. if the user is instructed to use the device when his head is in a known position).

The computer stores a three-dimensional computer model which it uses, according to conventional methods, to generate a display (e.g. a stereoscopic display) within the workspace. At least part of the model is shown with an apparent position within the workspace given by a mapping. Note that the user may have the ability to change the mapping or the portion of the model which is displayed, for example according to known techniques. For simplicity this display is not shown in FIGS. 1 and 2. Note that the model may include a labelling to indicate that certain sections of the model are to be displayed in a certain way, or not displayed at all.

The computer further stores data (a plane equation) defining a virtual plane 7 having a boundary (shown as rectangular in FIG. 7). The virtual plane has a correspondence to the surface 3, such that each point on the virtual plane 7 corresponds to a possible point of contact between the surface 3 and the tool 1. Conveniently, the point of contact between the surface 3 and the tool 1, and the point P, and the position 5 all lie on a single line, that is the line of sight from the point 5 to the point P indicated as V.

The point P corresponds under the mapping to a point on the three-dimensional model. The computer can register the point of the model, and selectively change the point of the model. For example, the model can be supplemented by data associated with that point. Note that the user works in three-dimensions on the two-dimensional surface 3.

For example, if the embodiment is used to edit a contour in the three-dimensional model, the computer maps the position of the stylus as it moves over the bottom surface to the position P on the model. An action of the user performed when the tool is at each of a number of points 9 on the surface 3 (e.g. clicking a button 4 on the tool, or pressing the surface 3 with a force above a threshold, as measured by a pressure sensor, such as a sensor within the tool or surface), produces corresponding nodes 11 on the model, which are joined to form the edited contour. The embodiment allows firm clicking on the nodes while editing in 3D space.

The operation of the tool 1 may in other respects resemble that of the known tool described above, and the tool may be operated in the 4 states discussed above. The states in which the projection of the present invention is applied may be the Check and DoAction states.

In these states there the computer performs the four steps of:

Compute and store the plane equation for the virtual plane 7.

Compute and store the vector V from the user's eye position to the tool tip.

Compute and store the intersection point P of V and the virtual plane 7.

Determine if P is outside the boundary of the contour plane 7. If so, then P is an invalid projected point, otherwise the point P is valid.

In the case that the system has the four states of the known system discussed above, the projection technique is used in the states Check, and DoAction

Note that there are various methods by which the user can select the virtual plane 7. Methods of selecting a plane within a workspace are known in the art. Alternatively, we propose that the virtual plane is selected by reaching into the workspace using an indicating tool (such as the tool 1).

During operation of the embodiment, the user does not see the tool 1, nor his hands. In one form of the invention the graphics system of the embodiment may generate a graphical representation of the tool 1 (for example, the tool 1 may be displayed as a virtual tool in the corresponding position on the virtual plane, as a virtual tool, such as a pen or a scalpel). More preferably, however, the user does not even see a virtual tool, but only sees the model and results of the particular application being performed, for example the contour being drawn in a contour editing application. This is preferable because firstly the model would most of the time obscure the virtual tool, and secondly because the job to do concerns the position of the projected points and the model, and not the 3D position of the virtual tool. For example, in a case in which the embodiment is used to display a computer model of a piece of bone, and the movements of the tool 1 correspond to those of a laser scalpel cutting the piece of bone, the user would hold the laser tool against the surface 3 for stability, and only see the effects of the laser ray on the bone.

FIGS. 1 and 2 also correctly describe the embodiment in the case of the DextroBeam, but in this case the position 5 is not the actual position of the eye. Instead, the position 5 is a predefined “virtual eye” and what is shown in FIGS. 1 and 2 is a first region containing the virtual eye, the virtual plane 7, the surface 3 and the tool 1. The first region has a one-to-one relationship (second mapping) with a second region containing the real eye. The model is preferably displayed to the user in an apparent location in the second region such that its relationship with the real eye is equal to the relationship between the position 5 and the position of the model under the first mapping in the first region shown in FIGS. 1 and 2.

1. A computer-implemented method for permitting a user to interact with a three-dimensional computer model, the method including:
storing the model, a mapping defining a geometrical correspondence between portions of the model and respective portions of a real world workspace, and data defining a virtual plane in the workspace;
and repeatedly performing:
generating an image of at least part of the model;
determining a position of an input device on a solid surface;
determining a corresponding location on the virtual plane; and
modifying a portion of the model corresponding to the determined location on the virtual plane under the mapping.

2. A method according to claim 1 in which the determined position on the surface and the corresponding location on the virtual plane both lie on a line which includes a position representative of a user's eye.

3. The method of claim 1, wherein the user performs an action on the input device to indicate a plurality of isolated points on the surface, thereby indicating corresponding points on the model.

4. The method of claim 3, wherein, the input device has a user operated button, and the action includes operating the button.

5. The method of claim 1, wherein the image is a stereoscopic image.

6. An apparatus for permitting a user to interact with a three-dimensional computer model, the apparatus including:
a processor for storing the model, a mapping defining a geometrical correspondence between portions of the model and respective portions of a real workspace, and data defining a virtual plane in the workspace;
display means controlled by the processor for generating an image of at least part of the model;
an input device arranged to move on a solid surface; and
a position sensor for determining the position of the input device on the surface;
the processor being arranged to use the determined position on the surface to determine a corresponding location on the virtual plane, and to modify the portion of the model corresponding to the location on the virtual plane under the mapping.

7. The apparatus of claim 6, wherein the processor is arranged to determine the corresponding location on the virtual plane by:
defining a line of sight extending from the position on the surface to a position representing the user's eye; and
determining the corresponding location on the virtual plane as the point of intersection of the line with the virtual plane.

8. The apparatus of claim 6, wherein the tool includes a control device responsive to a control action performed by the user.

9. The apparatus of claim 6, wherein the display means generates a stereoscopic image.

10. The apparatus of claim 7, wherein the tool includes a control device responsive to a control action performed by the user.

11. The apparatus of claim 6, wherein the display means generates a stereoscopic image.

12. The apparatus of claim 7, wherein the display means generates a stereoscopic image.

13. The apparatus of claim 8, wherein the display means generates a stereoscopic image.

14. The apparatus of claim 10, wherein the display means generates a stereoscopic image.

15. The method of claim 2, wherein the user performs an action on the input device to indicate a plurality of isolated points on the surface, thereby indicating corresponding points on the model.

16. The method of claim 15, wherein the input device has a user operated button, and the action includes operating the button.

17. The method of claim 2, wherein the image is a stereoscopic image.

18. The method of claim 3, wherein the image is a stereoscopic image.

19. The method of claim 4, wherein the image is a stereoscopic image.

20. The method of claim 15, wherein the image is a stereoscopic image.

21. The method of claim 16, wherein the image is a stereoscopic image.
